(19) United States
(12) Patent Application Publication
(10) Pub. No.: US 2015/0288237 A1
(43) Pub. Date: Oct. 8, 2015

(54) Motor

(71) Applicant: SUNON ELECTRONICS (KUNSHAN) CO., LTD., Jiangsu (CN)

(72) Inventors: Alex Horng, Kaohsiung City (TW); Yeh-Feng Chen, Kaohsiung City (TW); Wen-Te Chang Chien, Kaohsiung City (TW)

(21) Appl. No.: 14/631,902

(22) Filed: Feb. 26, 2015

(30) Foreign Application Priority Data
Apr. 8, 2014 (TW) 103112856

(51) Int. Cl. H02K 3/18; H02K 5/16; H02K 5/10

(52) U.S. Cl. CPC H02K 3/18; H02K 5/10; H02K 5/161

(57) ABSTRACT

A motor includes: a base having a shaft tube with a first opening and a second opening at two opposite ends respectively, with a bearing received in the shaft tube; a stator coupled with the base; a rotor having a shaft and a hub, the shaft extending through the first opening and coupling with the bearing, the hub coupling with the shaft and having a through hole for a positioning tool to insert, and the hub further having a permanent magnet, with a gap formed between the permanent magnet and the stator; and a bottom lid coupling with the shaft tube and covering the second opening.

### BACKGROUND OF THE INVENTION

1. Field of the Invention

The present invention generally relates to a motor and, more particularly, to a motor can be easily assembled.

2. Description of the Related Art

Referring to FIG. 1, a conventional motor 9 includes a base 91, a stator 92 and a rotor 93. The base 91 has a shaft tube 911 with a top opening 912 and a bottom opening 913, and the shaft tube 911 receives a bearing 914 inside. The stator 92 is mounted on the shaft tube 911 around a periphery thereof. The rotor 93 includes a shaft 931 and a hub 932. The shaft 931 extending through the top opening 912 by one end, so as to be rotatably coupled with the bearing 914, with a limiting washer 933 engaging with the shaft 931 and thus preventing the shaft 931 from falling off via the top opening 912. The other end of the shaft 931 firmly couples with the hub 932. An invention of the above conventional motor 9 is disclosed by United States patent with the title of “FIXING STRUCTURE FOR AN AXLE TUBE OF A MOTOR” and a publication number of U.S. Pat. No. 6,400,054.

Conventionally, there is usually a bottom lid 94 mounted to the shaft tube 911 to block the bottom opening 913, so as to achieve specific functions such as anti-dust and oil-preservation. The bottom lid 94 is usually positioned at the bottom opening 913 by engaging with or tightly fitting with the shaft tube 911. Furthermore, in order to ensure that the bottom lid 94 can be smoothly mounted into the bottom opening 913 in assembly, a fixture for abutting a top surface of the hub 932 of the rotor 93 is used for axially position the motor 9, and thus a worker can press the bottom lid 94 into the bottom opening 913 of the shaft tube 911 in a direction form the bottom opening 913 toward the top opening 912.

However, the rotor 93 may keep rotating when the worker attempts to axially position the motor 9 since the hub 932 rotatably coupling with the bearing 914 via the shaft 931 is rotatable relative to the base 91. Even though the limiting washer 933 is used, it can only limit the axial movement of the rotor 93, not the rotation of the rotor 93. Therefore, the rotation of the rotor 93 during assembly of the motor 9 may cause problems such as the shift in position of the abutted fixture due to the rotated hub 932 and thus lead to inconvenience of assembly, lower the quality of the motor 9, and unstable performance.

### SUMMARY OF THE INVENTION

What is needed is a motor unnecessary to be assembled via a tool positioning the hub of this motor during assembly thereof, so as to be manufactured smoothly, conveniently and fast.

In one implementation, a motor includes: a base having a shaft tube with a first opening and a second opening at two opposite ends respectively, with a bearing received in the shaft tube; a stator coupled with the base; a rotor having a shaft and a hub, the shaft extending through the first opening and coupling with the bearing, the hub coupling with the shaft and having a through hole for a positioning tool to insert, and the hub further having a permanent magnet, with a gap formed between the permanent magnet and the stator; and a bottom lid coupling with the shaft tube and covering the second opening.

In this implementation, one or more of the following features may be included that: the through hole axially aligns with an edge of the shaft tube, with the edge defining the first opening; the through hole axially aligns with the stator; the stator has a silicon steel member, a insulating member, and a coil, with the insulating member coupling with the silicon steel member, the coil winding around an outer periphery of the insulating member, the coil electrically connecting with a driving circuit, and the through hole of the hub aligning with the insulating member of the stator; the stator has a silicon. steel member, a insulating member, and a coil, with. the insulating member having a first bobbin and a second bobbin coupling to two opposite ends of the silicon steel member respectively, the coil winding around an outer periphery of the insulating member, the coil electrically connecting with a driving circuit, and the through hole of the hub aligning with the first bobbin of the stator; the stator has a silicon steel member, a insulating member, and a coil, with the insulating member coupling with the silicon steel member, the coil winding around an outer periphery of the insulating member, the coil electrically connecting with a driving circuit, and the through hole of the hub aligning with the silicon steel member of the stator; a cover couples with the hub and seals the through hole; the cover is a rubber cover, a plastic cover, or a sticker; the cover has a pin extending into and engage inside the through hole; the hub has an indent part receiving the cover; a top of the cover aligns with a top of the hub; a top of the cover is lower than a top of the hub; the shaft tube receives an anti-disengaging member coupling with the rotor; the anti-disengaging member is a limiting washer or a thrust plate; the shaft tube receives a pressing member pressing and positioning the bearing; there is a layer of diamond like carbon formed on surfaces of the shaft; the shaft tube is made of metal; the base has a plate detachably connecting with the shaft tube, with a connecting sleeve arranged between the shaft tube and the plate; a sealing member is disposed between the shaft tube and the bottom lid; a first shoulder portion is formed on an inner periphery of the shaft tube, a second shoulder portion is formed on an outer periphery of the bottom lid, the first shoulder portion is opposite to the second shoulder portion, and the sealing member is disposed between the first and second shoulder portions; and the sealing member is sandwiched by the first and second shoulder portions.

### BRIEF DESCRIPTION OF THE DRAWINGS

The present invention will become more fully understood from the detailed description given hereinafter and the accompanying drawings which are given by way of illustration only, and thus are not limitative of the present invention, including:

FIG. 1 is a cross-sectional view of a conventional motor.

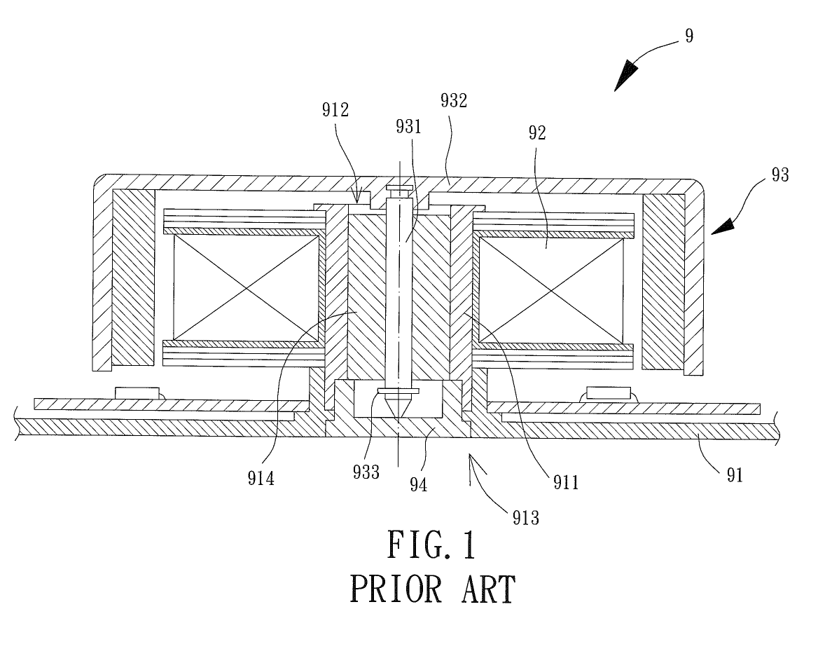

FIG. 2 is a cross-sectional view of a motor according to a preferred embodiment of the present disclosure, with the hub of the motor having a through hole aligning with an edge of a shaft tube.

FIG. 3 is a cross-sectional view of the motor according to the preferred embodiment, with the through hole of the hub aligning with a silicon steel member of a stator.

FIG. 4 is a cross-sectional view of the motor according to the preferred. embodiment, with the through hole of the hub aligning with an insulating member of a stator.

FIG. 5 is a cross-sectional view of a motor according to another embodiment, with a cover mounted on a hub to cover a through hole.

FIG. 6 is a cross-sectional view of the motor according to the preferred embodiment, which shows the process of assembly.

In the various figures of the drawings, the same numerals designate the same or similar parts. Furthermore, when the term “first,” “second,” “top,” “bottom,” and similar terms are used hereinafter, it should be understood that these terms refer only to the structure shown in the drawings as it would appear to a person viewing the drawings, and are utilized only to facilitate describing the invention.

### DETAILED DESCRIPTION OF THE INVENTION

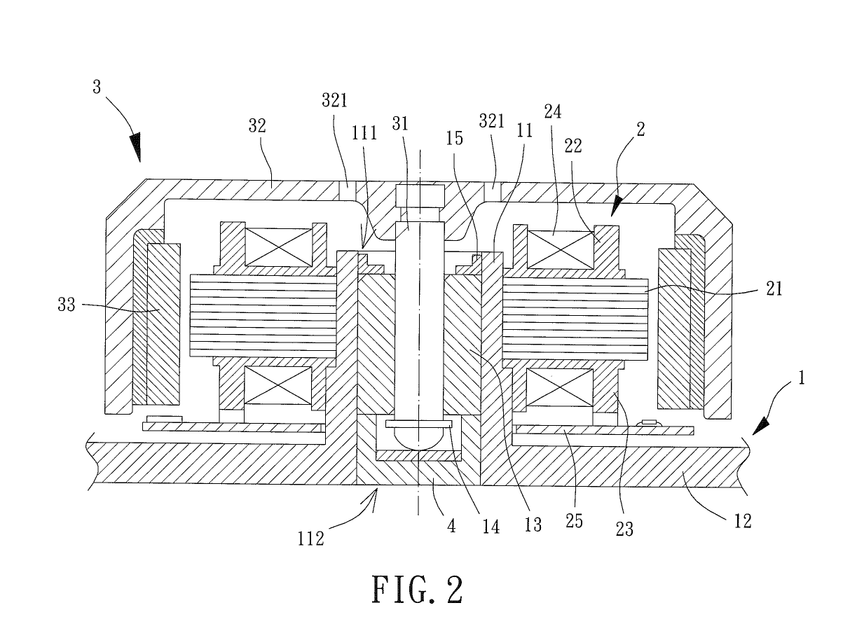

Referring to FIG. 2, the motor of the preferred embodiment of this disclosure includes a base 1, a stator 2, a rotor 3, and a bottom lid 4. The base 1 is adapted to be coupled by the stator 2 and the bottom lid 4, and the rotor 3 is rotatably coupled with the stator 2, so that the stator 2 can drive the rotor 3 to rotate.

The base 1 includes a shaft tube 11 having a first opening 111 and a second opening 112 respectively at two opposite ends thereof. In this embodiment, the base 1 further includes a plate 12 that connects with the shaft tube 11 integrally or detachably, wherein an integral connection of the shaft tube 11 and plate 12 as shown in FIG. 2 may simplify the structure of the base 1. Furthermore, a bearing 13 is received inside the shaft tube 11 for the rotor 3 to couple with, and thus the rotor 3 is able to rotate relatively to the base 1. Preferably, the shaft tube 11 may also receive an anti-disengaging member 14 and a pressing member 15. The anti-disengaging member 14 couples with the rotor 3 in a way not disturbing the rotation of the rotor 3, such as a limiting washer, and is adapted to avoid the rotor 3 disengaging from the bearing 13 received inside the shaft tube 11. The pressing member 15 is adapted to press and position the bearing 13, so as to prevent the bearing 13 as well as the rotor 3 from falling out of the shaft tube 11. In practical use, the elements inside the shaft tube 11 are added or omitted according to the need and thus not limited.

The stator 2 may be coupled with the base 1 at the shaft tube 11 or the plate 12. In this embodiment, the stator 2 is arranged around the shaft tube 11 and abuts against the periphery of the shaft tube 11. The stator 2 includes a silicon steel member 21, a first bobbin 22, a second bobbin 23 and a coil 24. The silicon steel member 21 can be in the form of a pile of silicon steel plates or a single silicon steel plate. The first bobbin 22 and second bobbin 23 may be integrally connected as a one-piece insulating member formed by injection molding, and respectively couple to two opposite ends of the silicon steel member 21. The coil 24 winds around an outer periphery of the insulating member. Furthermore, the stator may further include a driving circuit 25 settled on the base 1 as shown in FIG. 2 or outside the motor, with the driving circuit 25 electrically connecting with the coil 24.

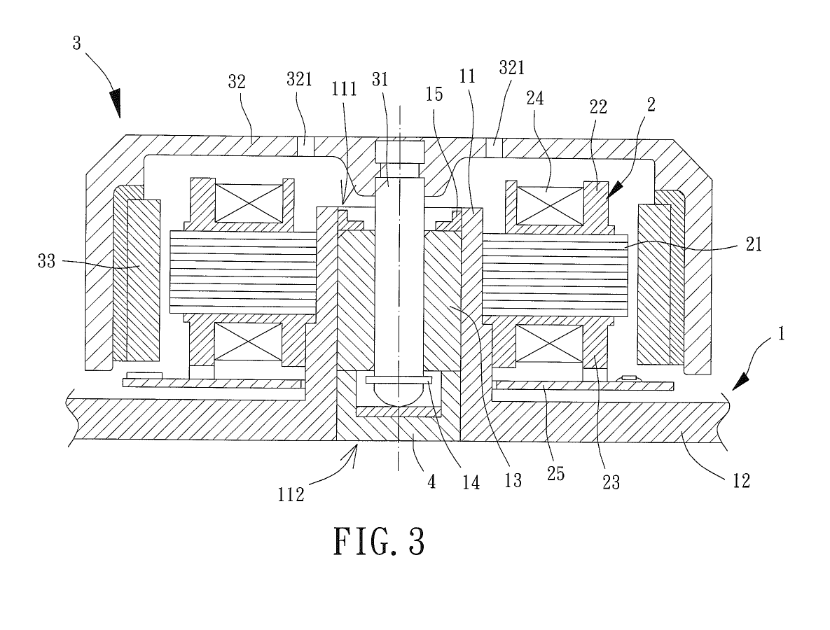

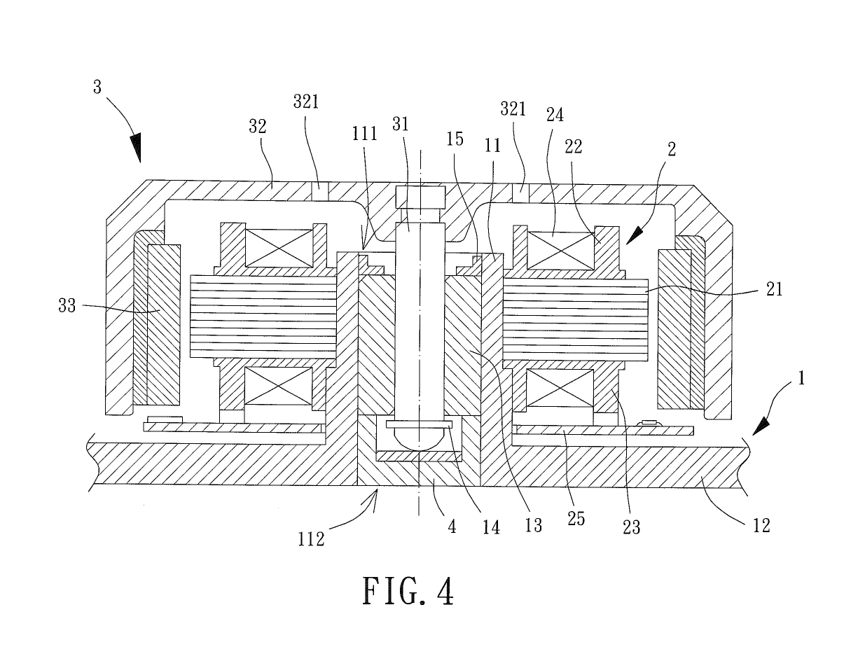

The rotor 3 includes a shaft 31 and a hub 32. The shaft 31 extends through the first opening 111 of the shaft tube 11 and couples with the bearing 13 by an end. Preferably, there is a layer of diamond like carbon (DLC) formed on the surfaces of the shaft 31, so as to improve the abradability of the shaft 31. The hub 32 couples with the other end of the shaft 31, and the hub 32 has a through hole 321 for a positioning tool to insert and engage during assembly, with the through hole 321 axially misaligned with the shaft 31. Preferably, the through hole 321 axially aligns with an edge of the shaft tube 11 defining the first opening 111 as shown in FIG. 2, axially aligns with the silicon steel member 21 of the stator 2 as shown in FIG. 3, or axially aligns with the insulating member, such as the first bobbin 22, as shown in FIG. 4. Additionally, the hub 32 further includes a permanent magnet 33 corresponding to the stator 2 radially, with a gap formed between the permanent magnet 33 and the stator 2. Accordingly, the rotor 3 can be driven by the alternative magnetic field generated by the stator 2 when the coil 24 is energized.

The bottom lid 4 is mounted on the shaft tube 11 and covers the second opening 112. The bottom lid 4 may couple with the shaft tube 11 by tight fitting or engagement.

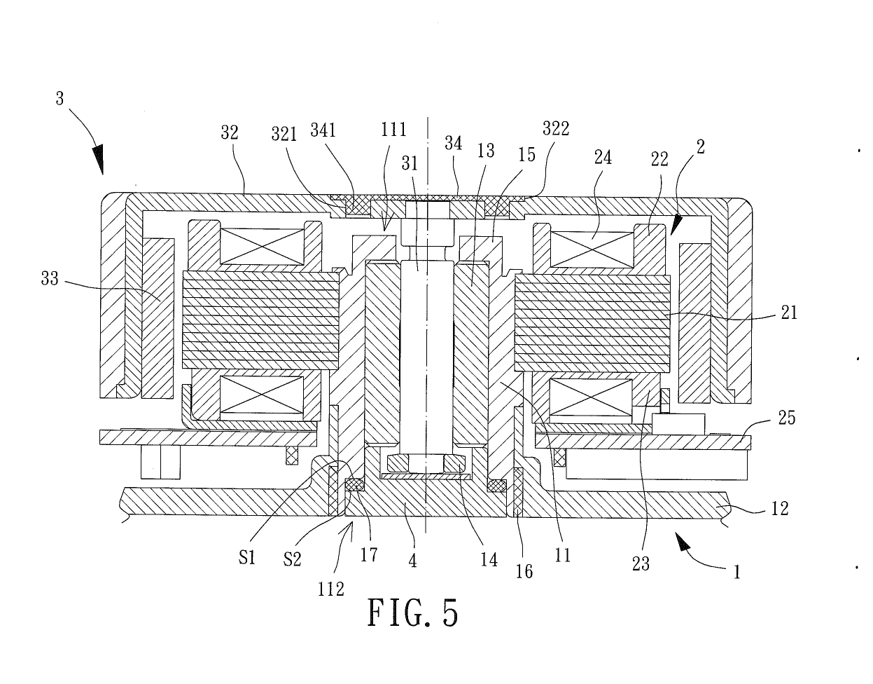

Referring to FIG. 5, another embodiment of the disclosure is shown, which means that any kind of motor can be modified based on the idea of the above disclosure to provide the through hole 321 in the hub 32 for a positioning tool to insert and engage. Specifically, there is a cover 34 mounted on the hub 32, and this cover 34 is a rubber cover, a plastic cover, or a sticker. The cover 34 is adapted to seal the through hole 321, so as to avoid dust entering the motor via the through hole 321 once the assembly of the motor is completed. Preferably, if the cover 34 is made by rubber or plastic, the cover 34 has a pin 341 to extend into and engage inside the through hole 321 for firmly coupling the cover 34 with the hub 32. Moreover, the hub 32 may further include an indent part 322 to receive the cover 34, so that the top of the cover 34 can align with or be lower than the top of the hub 32, and thus the cover 34 does not protrude from the top of the hub 32. Preferably, the top of the cover 34 aligns with the top of the hub 32, so as to avoid wind noise in operation. Furthermore, the shaft tube 11 is detachably coupled with the plate 12 and is made of metal, with a connecting sleeve 16 sandwiched between the shaft tube 11 and the plate 12 so as to firmly combine the shaft tube 11 and the plate 12. A thrust plate serves as the anti-disengaging member 14 to avoid the rotor 3 disengaging from the shaft tube 11, and the thrust plate is coupled with the shaft 31 of the rotor 3 integrally or detachably. Besides, the pressing member 15 adapted to position the bearing 13 is formed by a bent portion of the shaft tube 11, which is around the first opening 111 and extends inwards.

Referring FIG. 5 again, a sealing member 17 is disposed between the shaft tube 11 and the bottom lid 4 and may be a rubber or plastic packing ring for avoiding oil leakage of the shaft tube 11 via a gap between the shaft tube 11 and the bottom lid 4. In this embodiment, a first shoulder portion “S1” is formed on the inner periphery of the shaft tube 11, and a second shoulder portion “S2” is formed on the outer periphery of the bottom lid 4. Accordingly, the first shoulder portion “S1” of the shaft tube 11 is opposite to the second shoulder portion “S2” of the bottom lid 4, and the sealing member 17 is disposed between and sandwiched by the first and second shoulder portions “S1,”.“S2.” Therefore, not only an ideal performance of oil sealing is achieved, but also a reliable positioning of the sealing member 17 between the shaft tube 11 and the bottom lid 4.

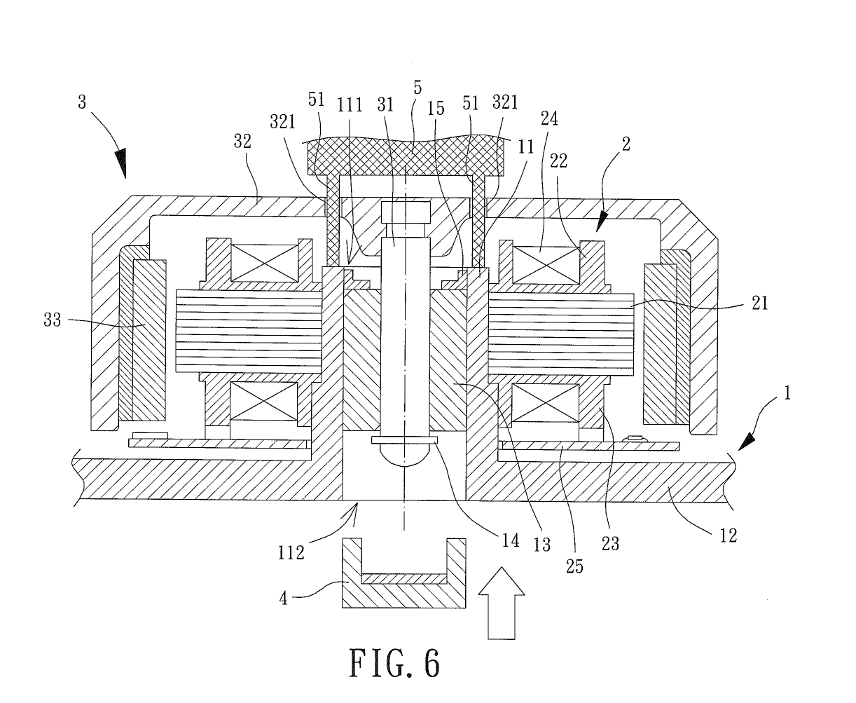

Now, please refer to FIG. 6. With the above disclosed through hole 321, when the bottom lid 4 is going to be coupled onto the shaft tube 11 to cover the second opening 112 in assembly, a positioning tool 5 with a positioning pin 51 is adapted to extend the through hole 321 by the positioning pin 51. Thus, the positioning pin 51 firmly abuts against the edge of the shaft tube 11 defining the first opening 111, especially when the shaft tube 11 is made by metal; alternatively, the positioning pin 51 can abut against the stator 2. Therefore, the positioning tool 5 as well as the positioning pin 51 does not shift relatively to the bottom lid 4 in assembly since, instead of abutting against the rotor 3, the positioning tool 5 abuts against the shaft tube 11 or stator 2 that does not rotate relatively to the bottom lid 4. Accordingly, a worker can press the bottom lid 4 in a direction from the second opening 112 toward the first opening 111, so as to push and couple the bottom lid 4 inside the shaft tube 11 to cover the second opening 112. Namely, with the through hole 321 aligning with the edge of the shaft tube 11 or the stator 2, the positioning tool 5 can easily fix the positions and orientations of the base 1, stator 2, and rotor 3. Thus, a worker can easily apply the axial force to the bottom lid 4 during assembly of the motor since there is no relative rotation between the rotor 3 and the base 1 or stator 2.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A motor, comprising:
a base having a shaft tube with a first opening and a second opening at two opposite ends respectively, with a bearing received in the shaft tube;
a stator coupled with the base;
a rotor having a shaft and a hub, the shaft extending through the first opening and coupling with the bearing, the hub coupling with the shaft and having a through hole for a positioning tool to insert, and the hub further having a permanent magnet, with a gap formed between the permanent magnet and the stator; and
a bottom lid coupling with the shaft tube and covering the second opening.

2. The motor as claimed in claim 1, wherein the through hole axially aligns with an edge of the shaft tube, with the edge defining the first opening.

3. The motor as claimed in claim 1, wherein the through hole axially aligns with the stator.

4. The motor as claimed in claim 3, wherein the stator has a silicon steel member, a insulating member, and a coil, with the insulating member coupling with the silicon steel member, the coil winding around an outer periphery of the insulating member, the coil electrically connecting with a driving circuit, and the through hole of the hub aligning with the insulating member of the stator.

5. The motor as claimed in claim 3, wherein the stator has a silicon steel member, a insulating member, and a coil, with the insulating member having a first bobbin and a second bobbin coupling to two opposite ends of the silicon steel member respectively, the coil winding around an outer periphery of the insulating member, the coil electrically connecting with a driving circuit, and the through hole of the hub aligning with the first bobbin of the stator.

6. The motor as claimed in claim 3, wherein the stator has a silicon steel member, a insulating member, and a coil, with the insulating member coupling with the silicon steel member, the coil winding around an outer periphery of the insulating member, the coil electrically connecting with a driving circuit, and the through hole of the hub aligning with the silicon steel member of the stator.

7. The motor as claimed in claim 1, wherein a cover couples with the hub and seals the through hole.

8. The motor as claimed in claim 7, wherein the cover is a rubber cover, a plastic cover, or a sticker.

9. The motor as claimed in claim 7, wherein the cover has a pin extending into and engage inside the through hole.

10. The motor as claimed in claim 7, wherein the hub has an indent part receiving the cover.

11. The motor as claimed in claim 7, wherein a top of the cover aligns with a top of the hub.

12. The motor as claimed in claim 7, wherein a top of the cover is lower than a top of the hub.

13. The motor as claimed in claim 1, wherein the shaft tube receives an anti-disengaging member coupling with the rotor.

14. The motor as claimed in claim 13, wherein the anti-disengaging member is a limiting washer or a thrust plate.

15. The motor as claimed in claim 1, wherein the shaft tube receives a pressing member pressing and positioning the bearing.

16. The motor as claimed in claim 1, wherein there is a layer of diamond like carbon formed on surfaces of the shaft.

17. The motor as claimed in claim 1, wherein the shaft tube is made of metal.

18. The motor as claimed in claim 1, wherein the base has a plate detachably connecting with the shaft tube, with a connecting sleeve arranged between the shaft tube and the plate.

19. The motor as claimed in claim 1, wherein a sealing member is disposed between the shaft tube and the bottom lid.

20. The motor as claimed in claim 19, wherein a first shoulder portion is formed on an inner periphery of the shaft tube, a second shoulder portion is formed on an outer periphery of the bottom lid, the first shoulder portion is opposite to the second shoulder portion, and the sealing member is disposed between the first and second shoulder portions.

21. The motor as claimed in claim 20, wherein the sealing member is sandwiched by the first and second shoulder portions.
